(19) United States
(12) Patent Application Publication
(10) Pub. No.: US 2012/0268649 A1
(43) Pub. Date: Oct. 25, 2012

(54) ELECTRONIC CAMERA

(75) Inventor: Mitsuaki Kurokawa, Toyonaka-shi (JP)

(73) Assignee: SANYO ELECTRIC CO., LTD., Osaka (JP)

(21) Appl. No.: 13/453,552

(22) Filed: Apr. 23, 2012

(30) Foreign Application Priority Data
Apr. 22, 2011 (JP) 2011-096487
Apr. 22, 2011 (JP) 2011-096489

(51) Int. Cl. H04N 5/225

(52) U.S. Cl. 348/370; 348/E05.024

(57) ABSTRACT

An electronic camera includes a plurality of light emitters. Each of a plurality of light emitters emits light in a mutually different manner. A plurality of optical systems are respectively corresponding to the plurality of light emitters. A selector selects a desired shooting mode from among a plurality of shooting modes in each of which a scene is captured in a mutually different manner. A driver drives a light emitter corresponding to the shooting mode selected by the selector out of the plurality of light emitters. A creator creates an electronic image based on an optical image went through an optical system corresponding to the light emitter driven by the driver out of the plurality of optical systems.

### CROSS REFERENCE OF RELAYED APPLICATION

The disclosure of Japanese Patent Application No. 2011-96487, which was filed on Apr. 22, 2011, and the disclosure of Japanese Patent Application No. 2011-96489, which was filed on Apr. 22, 2011 are incorporated herein by reference.

### BACKGROUND OF THE INVENTION

1. Field of the Invention

The present invention relates to an electronic camera. More particularly, the present invention relates to an electronic camera which creates an electronic image based on a plurality of optical images respectively went through a plurality of optical systems.

2. Description of the Related Art

According to one example of this type of camera, when a three-dimensional photographing mode is selected by a mode selecting switch, outputs of two video signal processing circuits are provided to a VTR section so as to be recorded as a three-dimensional video signal. On the other hand, when a two-dimensional photographing mode is selected by the mode selecting switch, only the output of one video signal processing circuit is provided to the VTR section so as to be recorded as a two-dimensional signal.

However, in the above-described camera, a light which irradiates a beam toward a subject is not arranged, and a driving manner of the light is not switched corresponding to the photographing mode. Thus, in the above-described camera, a quality of the recorded video signal is limited.

Moreover, according to another example of this type of camera, each of a plurality of optical systems forms an optical image on an imaging surface by conversing subject lights. A plurality of imaging elements are respectively assigned to the plurality of optical systems. A video displayer displays a stereo image that is based on a plurality of videos respectively outputted from the plurality of imaging elements. A recorder records a stereo image that is based on the plurality of videos. Here, the plurality of imaging elements transition between a first position in which a longer direction and a horizontal direction of an acceptance surface are closely matched and a second position in which the longer direction and a vertical direction of the acceptance surface are closely matched. Thereby, even in a compound camera apparatus, it becomes possible to photograph in a so-called vertical position.

However, in the above-described camera, a quality of the outputted video is not different among the plurality of imaging elements, and therefore, a diversification of representing the outputted video is limited.

### SUMMARY OF THE INVENTION

An electronic camera according to the present invention comprises: a plurality of light emitters each of which emits light in a mutually different manner; a plurality of optical systems respectively corresponding to the plurality of light emitters; a selector which selects a desired shooting mode from among a plurality of shooting modes in each of which a scene is captured in a mutually different manner; a driver which drives a light emitter corresponding to the shooting mode selected by the selector out of the plurality of light emitters; and a creator which creates an electronic image based on an optical image went through an optical system corresponding to the light emitter driven by the driver out of the plurality of optical systems.

According to the present invention, an imaging control program recorded on a non-transitory recording medium in order to control an electronic camera provided with a plurality of light emitters each of which emits light in a mutually different manner and a plurality of optical systems respectively corresponding to the plurality of light emitters, the program causing a processor of the electronic camera to perform the steps comprises: a selecting step of selecting a desired shooting mode from among a plurality of shooting modes in each of which a scene is captured in a mutually different manner; a driving step of driving a light emitter corresponding to the shooting mode selected by the selecting step out of the plurality of light emitters; and a creating step of creating an electronic image based on an optical image went through an optical system corresponding to the light emitter driven by the driving step out of the plurality of optical systems.

According to the present invention, an imaging control method executed by an electronic camera provided with a plurality of light emitters each of which emits light in a mutually different manner and a plurality of optical systems respectively corresponding to the plurality of light emitters, comprises: a selecting step of selecting a desired shooting mode from among a plurality of shooting modes in each of which a scene is captured in a mutually different manner; a driving step of driving a light emitter corresponding to the shooting mode selected by the selecting step out of the plurality of light emitters; and a creating step of creating an electronic image based on an optical image went through an optical system corresponding to the light emitter driven by the driving step out of the plurality of optical systems.

An electronic camera according to the present invention comprises: a plurality of light emitters each of which emits light in a mutually different manner; a plurality of imagers which respectively correspond to the plurality of light emitters and respectively output a plurality of electronic images each of which has a mutually different quality; a plurality of holding members each of which integrally holds a light emitter and an imager corresponding to each other; and a combining member which combines the plurality of holding members with one another in a manner in which relative attitudes of the plurality of holding members become variable.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is a perspective view showing an appearance of the embodiment in FIG. 2;

FIG. 4 is an illustrative view showing one example of a scene captured by the embodiment in FIG. 2;

FIG. 5 is an illustrative view showing one example of a configuration of an optical/imaging system applied to the embodiment in FIG. 2;

FIG. 6 is an illustrative view showing one example of an assigned state of an evaluation area EVA in an imaging surface;

FIG. 7 is a flowchart showing one portion of behavior of a CPU applied to the embodiment in FIG. 2;

FIG. 8 is a flowchart showing another portion of behavior of the CPU applied to the embodiment in FIG. 2;

FIG. 9 is a flowchart showing still another portion of behavior of the CPU applied to the embodiment in FIG. 2;

FIG. 10 is a flowchart showing yet another portion of behavior of the CPU applied to the embodiment in FIG. 2;

FIG. 11 is a flowchart showing still another portion of behavior of the CPU applied to the embodiment in FIG. 2;

FIG. 12 is a flowchart showing one portion of behavior of the CPU applied to another embodiment of the present invention;

FIG. 13 is a block diagram showing a configuration of another embodiment of the present invention;

FIG. 14 is a block diagram showing a basic configuration of one embodiment of the present invention;

FIG. 15 is a block diagram showing a configuration of one embodiment of the present invention;

FIG. 16 is an exploded perspective view showing an appearance of the embodiment in FIG. 15;

FIG. 17 is a perspective view showing an appearance of the embodiment in FIG. 15;

FIG. 18 is an illustrative view showing one example of a scene captured by the embodiment in FIG. 15;

FIG. 19 is an illustrative view showing one example of a configuration of an optical/imaging system applied to the embodiment in FIG. 15;

FIG. 20 is an illustrative view showing one example of an assigned state of an evaluation area EVA in an imaging surface;

FIG. 21 is a flowchart showing one portion of behavior of a CPU applied to the embodiment in FIG. 15;

FIG. 22 is a flowchart showing another portion of behavior of the CPU applied to the embodiment in FIG. 15;

FIG. 23 is a flowchart showing still another portion of behavior of the CPU applied to the embodiment in FIG. 15;

FIG. 24 is a flowchart showing yet another portion of behavior of the CPU applied to the embodiment in FIG. 15;

FIG. 25 is a flowchart showing still another portion of behavior of the CPU applied to the embodiment in FIG. 15; and

FIG. 26 is a perspective view showing an appearance of another embodiment of the present invention.

### DETAILED DESCRIPTION OF THE PREFERRED EMBODIMENTS

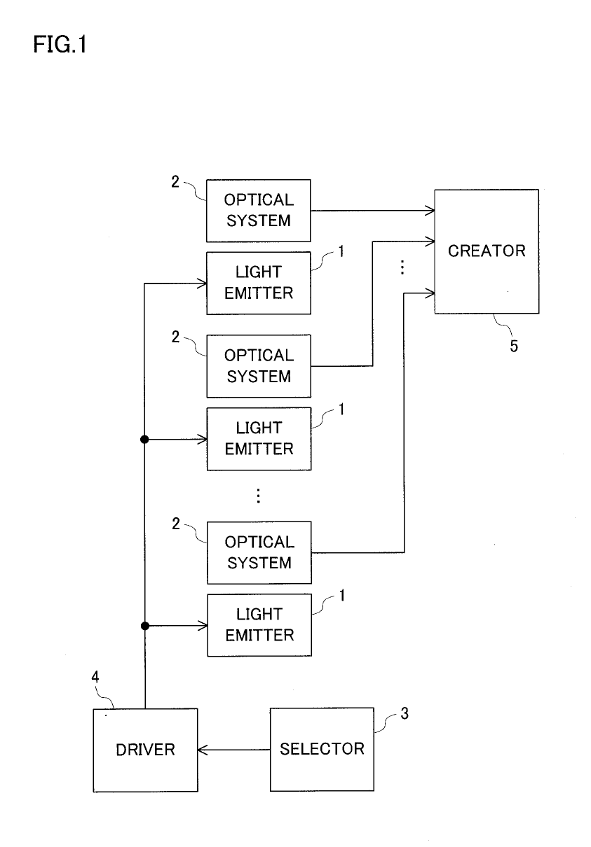

With reference to FIG. 1, an electronic camera according to one embodiment of the present invention is basically configured as follows: Each of a plurality of light emitters 1, 1, . . . emits light in a mutually different manner. A plurality of optical systems 2, 2, . . . are respectively corresponding to the plurality of light emitters 1, 1, . . . . A selector 3 selects a desired shooting mode from among a plurality of shooting modes in each of which a scene is captured in a mutually different manner. A driver 4 drives a light emitter 1 corresponding to the shooting mode selected by the selector 3 out of the plurality of light emitters 1, 1, . . . . A creator 5 creates an electronic image based on an optical image went through an optical system 2 corresponding to the light emitter 1 driven by the driver 4 out of the plurality of optical systems 2, 2, . . . .

Provided are the plurality of shooting modes in each of which the scene is captured in the mutually different manner and the plurality of light emitters 1, 1, . . . each of which emits light in the mutually different manner, and driven is the light emitter 1 corresponding to the selected shooting mode. The electronic image is created based on the optical image went through the optical system 2 corresponding to the driven light emitter 1. Thereby, a quality of the electronic image is improved.

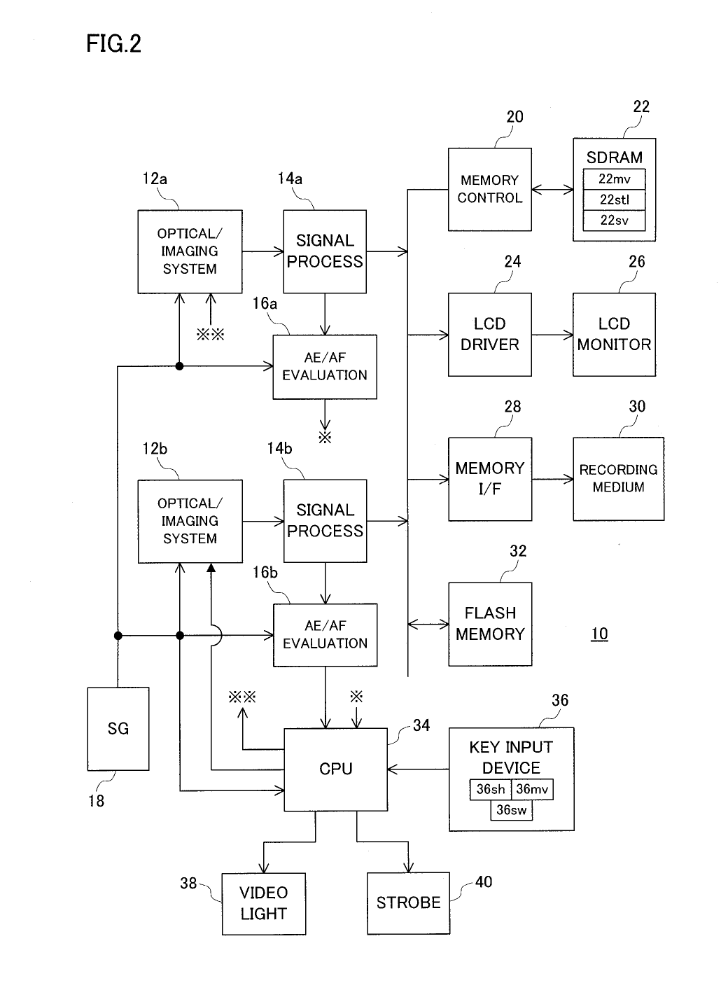

With reference to FIG. 2, a digital camera 10 according to one embodiment includes optical/imaging systems 12a and 12b capturing a common scene. When a power source is applied, under an imaging task, a CPU 34 activates the optical/imaging systems 12a and 12b. In response to a vertical synchronization signal Vsync periodically generated from an SG (Signal Generator) 18, both of the optical/imaging systems 12a and 12b repeatedly output raw image data representing a scene.

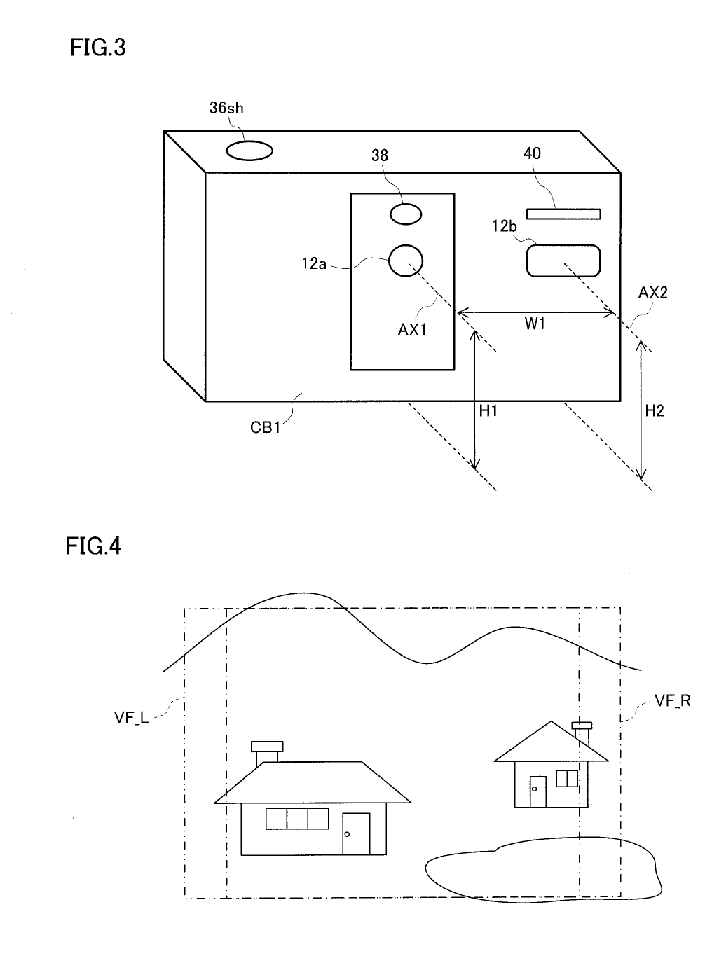

As shown in FIG. 3, the optical/imaging system 12a is fixedly arranged on an upper center portion of a front surface of a camera housing CB1, and the optical/imaging system 12b is fixedly arranged on an upper right portion of the front surface of the camera housing CB1. Moreover, a video light 38 described later is arranged near the optical/imaging system 12a, and a strobe light 40 described later is arranged near the optical/imaging system 12b. That is, the video light 38 is assigned to the optical/imaging system 12a, and the strobe light 40 is assigned to the optical/imaging system 12b.

Here, the optical/imaging systems 12a and 12b respectively have an optical axes AX1 and AX2, and a distance from a bottom surface of the camera housing CB1 to the optical axis AX1 (=H1) is coincident with a distance from the bottom surface of the camera housing CB1 to the optical axis AX2 (=H2). Moreover, a width between the optical axes AX1 and AX2 in a horizontal direction (=W1) is set about six centimeters by considering a width between both eyes of a person.

Thus, when a scene shown in FIG. 4 is spreading out before the camera housing CB1, the optical/imaging system 12a captures a scene belonging to a viewing field VF_R, whereas the optical/imaging system 12b captures a scene belonging to a viewing field VF_L. Since the optical/imaging systems 12a and 12b are arranged at the same height as each other in the camera housing CB1, horizontal positions of the viewing fields VF_R and VF_L are stirred, whereas vertical positions of the viewing fields VF_R and VF_L are coincident with each other.

Returning to FIG. 2, the raw image data outputted from the optical/imaging system 12a is applied to a signal processing circuit 14a, and the raw image data outputted from the optical/imaging system 12b is applied to a signal processing circuit 14b. Each of the signal processing circuits 14a and 14b performs processes, such as color separation, white balance adjustment, and YUV conversion, on the applied raw image data so as to write image data that complies with the YUV format into an SDRAM 22 through a memory control circuit 20.

One of the optical/imaging systems 12a and 12b is corresponding to a moving-image shooting mode, and the other of the optical/imaging systems 12a and 12b is corresponding to a still-image shooting mode. Below, an optical/imaging system corresponding to the moving-image shooting mode is defined as “optical/imaging system MV”, and an optical/imaging system corresponding to the still-image shooting mode is defined as “optical/imaging system STL”.

Initially when the power supply is applied, under a setting control task parallel to the imaging task, the CPU 34 initializes roles of the optical/imaging systems 12a and 12b. The optical/imaging system 12a is set as the “optical/imaging system MV”, and the optical/imaging system 12b is set as the “optical/imaging system STL”. Upon completion of initializing, illuminance of the scene captured by the optical/imaging systems 12a and 12b is calculated based on a luminance evaluation value described later, and the roles of the optical/imaging systems 12a and 12b are set in a manner different depending on a magnitude of the calculated illuminance and/or a state of the video light 38.

A reference value REF1 for controlling turning on/off is assigned to the video light 38, and a reference value REF2 for controlling light emission/non-light emission is assigned to the strobe light 40. Here, the reference value REF2 is greater than the reference value REF1.

When the illuminance is equal to or less than the reference value REF2, it is regarded that the video light 38 and/or the strobe light 40 is necessary. Therefore, the optical/imaging system 12a is set as the “optical/imaging system MV”, and the optical/imaging system 12b is set as the “optical/imaging system STL”. Also, when the video light 38 is being turned on at a current time point, the optical/imaging system 12a is set as the “optical/imaging system MV”, and the optical/imaging system 12b is set as the “optical/imaging system STL”.

In contrary, when the illuminance exceeds the reference value REF2 and the video light 638 is being turned off, it is regarded that any of the video light 38 and the strobe light 40 is unnecessary, and therefore, the roles of the optical/imaging systems 12a and 12b are switched in response to an operation of an imaging setting switch 36sw.

Specifically, when the imaging setting switch 36sw is set to “ST1”, the optical/imaging system 12a is set as the “optical/imaging system MV”, and the optical/imaging system 12b is set as the “optical/imaging system STL”. On the other hand, when the imaging setting switch 36sw is set to “ST2”, the optical/imaging system 12a is set as the “optical/imaging system STL”, and the optical/imaging system 12b is set as the “optical/imaging system MV”.

In the SDRAM 22, image data representing a scene captured in the optical/imaging system MV is stored in a moving image area 22mv, whereas image data representing a scene captured in the optical/imaging system SU is stored in a still-image area 22stl. An LCD driver 24 repeatedly reads out the image data stored in the moving image area 22mv through the memory control circuit 20, and drives an LCD monitor 26 based on the read-out image data. As a result, a real-time moving image (a live view image) representing the scene captured in the optical/imaging system MV is displayed on a monitor screen.

With reference to FIG. 5, the optical/imaging system 12a has a focus lens 121a, an aperture unit 122a and an imaging device 123a driven by drivers 124a, 125a and 126a, respectively. An optical image representing a scene enters, with irradiation, an imaging surface of the imaging device 123a via the focus lens 121a and the aperture unit 122a In response to a vertical synchronization signal Vsync applied from the SG 18, the driver 126a exposes the imaging surface and reads out electric charges produced thereby in a raster scanning manner. From the imaging device 123a, raw image data based on the read-out electric charges is outputted.

It is noted that, since the optical/imaging system 12b is similar to the optical/imaging system 12a, a duplicated description is omitted by substituting a symbol “b” for a symbol “a” which is assigned to a reference number of each member.

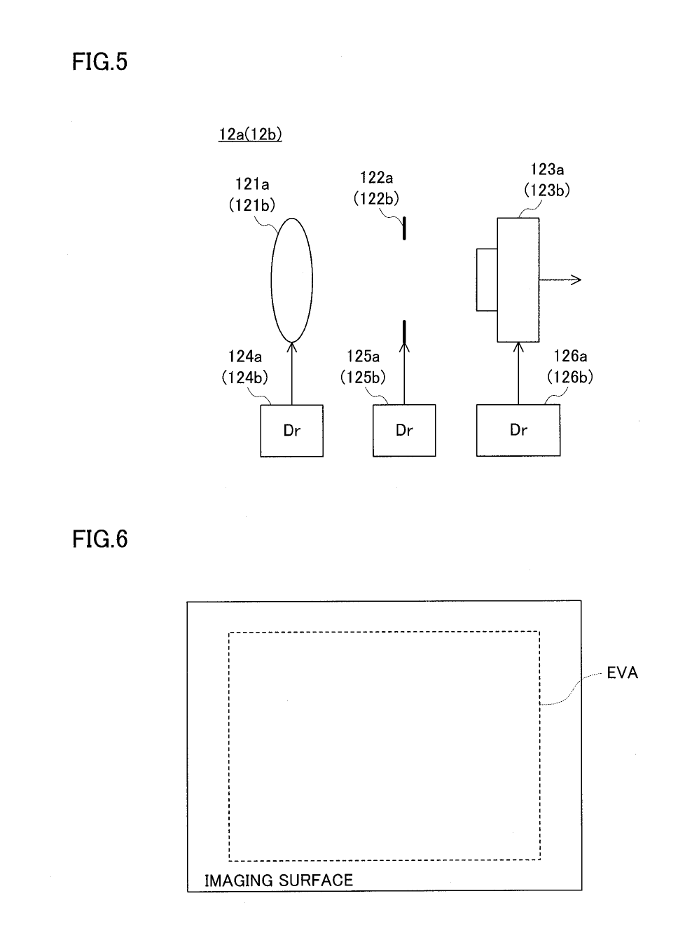

An evaluation area EVA is assigned to each of the imaging surfaces of the imaging devices 123a and 123b as shown in FIG. 6. An AE/AF evaluating circuit 16a shown in FIG. 2 repeatedly creates a luminance evaluation value and a focus evaluation value respectively indicating a brightness and a sharpness of the scene captured in the optical/imaging system 12a, based on partial image data belonging to the evaluation area EVA out of the YUV formatted image data produced by the signal processing circuit 14a.

Similarly, an AE/AF evaluating circuit 16b repeatedly creates a luminance evaluation value and a focus evaluation value respectively indicating a brightness and a sharpness of the scene captured in the optical/imaging system 12b, based on partial image data belonging to the evaluation area EVA out of the YUV formatted image data produced by the signal processing circuit 14b.

The CPU 34 executes, under the imaging task, an AE process for a moving image that is based on the luminance evaluation value outputted from each of the AE/AF evaluating circuits 16a and 16b so as to calculate an appropriate EV value. An aperture amount defining the calculated appropriate EV value is set to the drivers 125a and 125b, and an exposure time period defining the calculated appropriate EV value is set to the drivers 126a and 126b. As a result, a luminance of the image data outputted from each of the signal processing circuits 14a and 14b is adjusted appropriately.

Moreover, the CPU 34 executes, under the imaging task, an AF process for a moving image that is based on the focus evaluation value outputted from each of the AE/AF evaluating circuits 16a and 16b. Under a control of the CPU 34, the drivers 124a and 124b move the focus lenses 121a and 121b to a direction where a focal point exists. As a result, a sharpness of the image data outputted from each of the signal processing circuits 14a and 14b is adjusted appropriately.

When a movie button 36mv arranged in a key input device 36 is operated, the CPU 34 regards that the moving-image shooting mode is selected, and commands a memory I/F 28 to execute a moving-image recording process under the imaging task. The memory 1/F 28 creates a new moving image file in a recording medium 30 (the created moving image file is opened), and repeatedly reads out the image data stored in the moving image area 22mv of the SDRAM 22 through the memory control circuit 20 so as to contain the read-out image data into the moving image file in an opened state.

When the movie button 36mv is operated again, the CPU 34 regards that a selection of the moving-image shooting mode is cancelled, and commands the memory IT 28 to stop the moving-image recording process under the imaging task. The memory IT 28 ends reading-out of the image data from the moving image area 22mv, and closes the moving image file in the opened state. Thereby, a moving image continuously representing a desired scene is recorded on the recording medium 30 in a file format.

An operation of a shutter button 36sh arranged in the key input device 36 is accepted under the imaging task irrespective of executing/interrupting the moving-image recording process. When the shutter button 36sh is half-depressed, under the imaging task, the CPU 34 executes an AE process for a still-image and an AF process for a still image that are based on the luminance evaluation value and the focus evaluation value outputted from the AE/AF evaluating circuit corresponding to the optical/imaging system STL.

As a result of the AE process for a still image, an aperture amount and an exposure time period defining an optimal EV value are calculated. The calculated aperture amount is set to the driver (125a or 125b) for an aperture adjustment arranged in the optical/imaging system STL, and the calculated exposure time period is set to the drier (126a or 126b) for an image output arranged in the optical/imaging system STL. Thereby, a luminance of image data based on output of the optical/imaging system STL is adjusted to an optimal value.

Moreover, as a result of the AF process for a still image, a placement of the focus lens (121a or 121b) arranged in the optical/imaging system STL is finely adjusted near the focal point. Thereby, a sharpness of the image data based on output of the optical/imaging system STL is adjusted to an optimal value.

It is noted that, since the AE process for a moving image and the AF process for a moving image are repeatedly executed before the AE process for a still image and the AF process for a still image are executed, the AE process for a still image and the AF process for a still image are completed in a short time.

When the shutter button 36sh is full-depressed, the CPU 34 regards that the still-image shooting mode is selected, and executes a still-image taking process under the imaging task. As a result, the latest one frame of the image data stored in the still image area 22stl is evacuated to an evacuation area 22sv. Subsequently, the CPU 34 commands the memory l/F 28 to execute a still-image recording process under the imaging task.

The memory I/F 28 creates a new still image file in the recording medium 30 (the created still image file is opened), and repeatedly reads out the image data evacuated to the evacuation area 22sv through the memory control circuit 20 so as to contain the read-out image data into the still image file in an opened state. Upon completion of storing the image data, the memory I/F 28 closes the still image file in the opened state. Thereby, a still image instantaneously representing a desired scene is recorded on the recording medium 30 in a file format.

When the still-image recording process is executed in the middle of the moving-image recording process, the CPU 34 forms a link between the moving image file created by the moving-image recording process and the still image file created by the still-image recording process. Specifically, a file name of the moving image file is described in a header of the still image file, and a file name of the still image file is described in the file name of the moving image file. Thereby, a diversity of representing a reproduced image is improved; such as reproducing a moving image and a still image representing a common scene in a parallel state or a composed state.

Moreover, under a light-emission control task parallel with the setting control task and the imaging task, the CPU 34 controls turning on/off of the video light 38 in executing the moving-image recording process and light emission/non-light emission of the strobe light 40 at a time point at which the shutter button 36sh is fully depressed. Upon controlling, the illuminance calculated based on the luminance evaluation values from the AE/AF evaluating circuits 16a and 16b are referred to.

The video light 38 is turned on when the illuminance is equal to or less than the reference value REF1, whereas is turned off when the illuminance exceeds the reference value REF1. Moreover, the strobe light 40 is emitted when the illuminance is equal to or less than the reference REF2, whereas is set to non-light emission when the illuminance exceeds the reference REF2. It is noted that, if the video light 38 is being turned on when the strobe light 40 is emitted, the video light 38 is temporarily turned off at a timing of the strobe light 40 being emitted. Thereby, a quality of the image data contained in each of the moving image file and the still image file is improved.

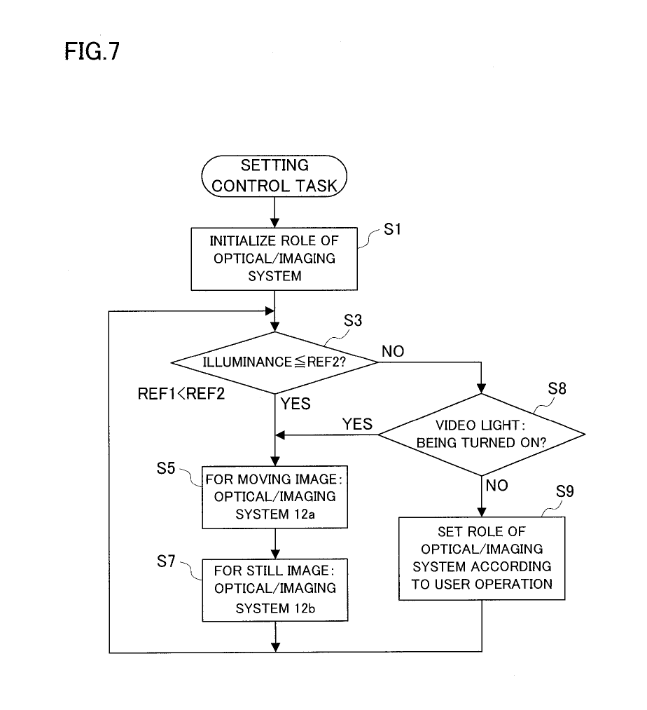

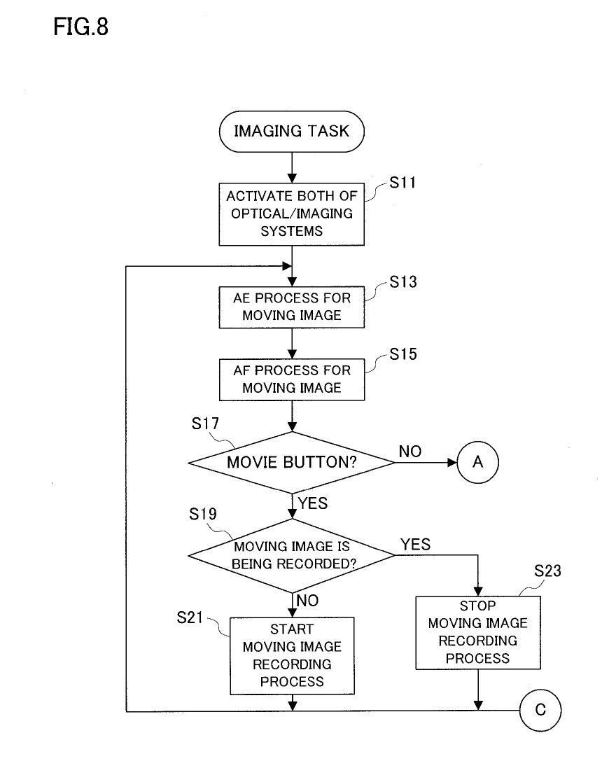

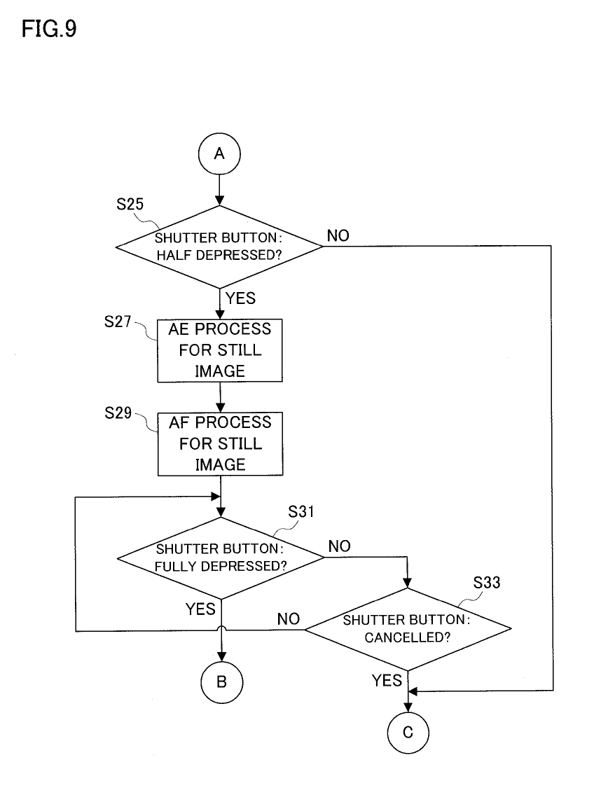

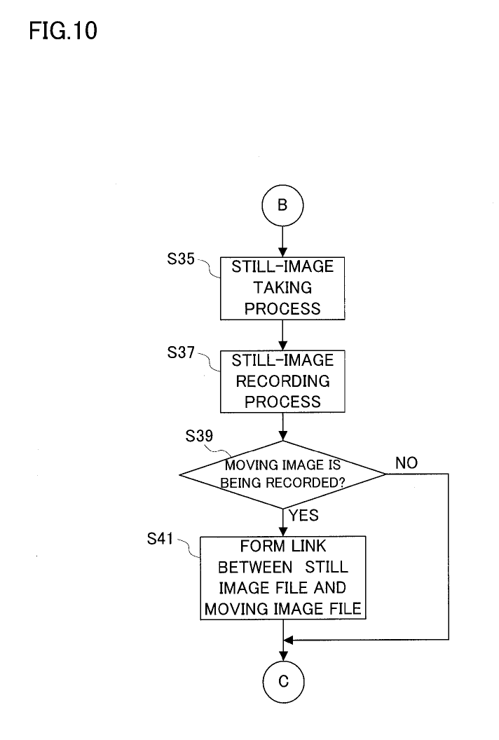

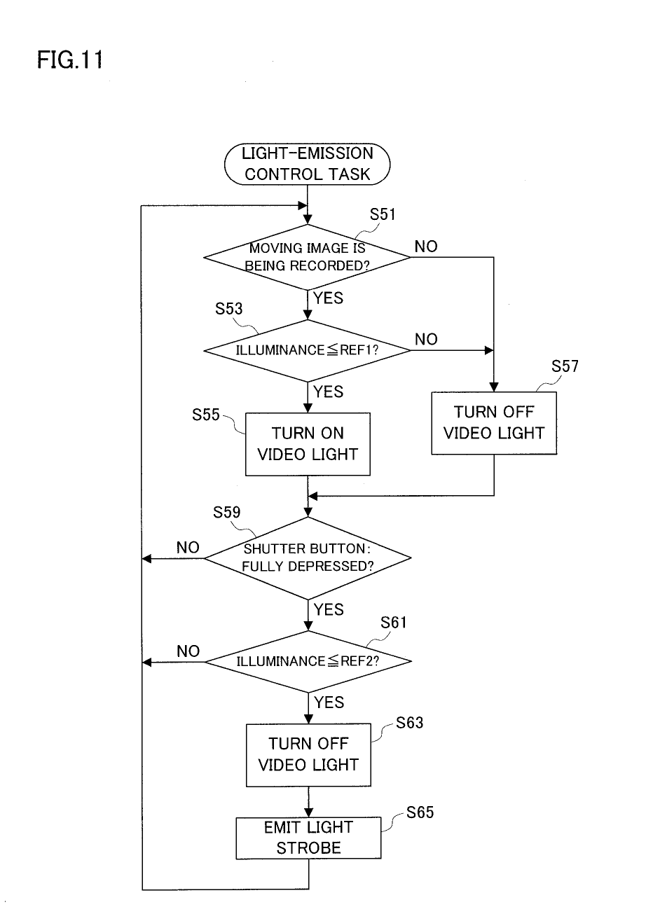

The CPU 34 executes, under a control of a multi task operating system, the setting control task shown in FIG. 7, the imaging task shown in FIG. 8 to FIG. 10 and the light emission-control task shown in FIG. 11, in a parallel manner.

With reference to FIG. 7, in a step S1, roles of the optical/imaging systems 12a and 12b are initialized. The optical/imaging system 12a is set as the “optical/imaging system MV”, and the optical/imaging system 12b is set as the “optical/imaging system STL”. In a step S3, it is determined whether or not illuminance of the scenes captured by the optical/imaging systems 12a and 12b is equal to or less than the reference REF1, based on luminance evaluation values outputted from the AE/AF evaluating circuits 16a and 16b. Moreover, in a step S8, it is determined whether or not the video light 38 is being turned on.

When any one of a determined result of the step S3 and a determined result of the step S8 is YES, the process returns to the step S3 via processes in steps S5 to S7, whereas when any of the determined result of the step S3 and the determined result of the step S8 is NO, the process returns to the step S3 via a process in a step S9. In the step S5, the optical/imaging system 12a is set as the “optical/imaging system MV”, and in the step S7, the optical/imaging system 12b is set as the “optical/imaging system STL”. In the step S9, the roles of the optical/imaging systems 12a and 12b are set according to a state of the imaging setting switch 36sw.

As a result of the process in the step S9, when the imaging setting switch 36sw is set to “ST1”, the optical/imaging system 12a is set as the “optical/imaging system MV”, and the optical/imaging system 12b is set as the “optical/imaging system SU”. When the imaging setting switch 36sw is set to “ST2”, the optical/imaging system 12a is set as the “optical/imaging system STL”, and the optical/imaging system 12b is set as the “optical/imaging system MV”.

With reference to FIG. 8, in a step S11, the optical/imaging systems MV and STL are activated. As a result, image data representing a scene captured in the optical/imaging system MV is written into the moving image area 22mv of the SDRAM 22, image data representing a scene captured in the optical/imaging system STL is written into the still image area 22stl of the SDRAM 22, and a live view image that is based on the image data stored in the moving image area 22mv is displayed on the LCD monitor 26.

In a step S13, the AE process for a moving image is executed, and in a step S15, the AF process for a moving image is executed. As a result of the process in the step S13, a luminance of the image data outputted from each of the signal processing circuits 14a and 14b is adjusted appropriately. Moreover, as a result of the process in the step S15, a sharpness of the image data outputted from each of the signal processing circuits 14a and 14b is adjusted appropriately.

In a step S17, it is determined whether or not the movie button 36mv is operated, and when a determined result is YES, the process advances to a step S19. In the step S19, it is determined whether or not a moving-image process is being executed, and when a determined result is YES, it is regarded that the moving-image shooting mode is selected, and thereafter, the moving-image recording process is started in a step S21, whereas when the determined result is NO, it is regarded that a selection of the moving-image shooting mode is cancelled, and thereafter, the moving-image recording process is stopped in a step S23. Upon completion of the process in the step S21 or S23, the process returns to the step S13.

As a result of the processes in the steps S21 and S23, the image data taken into the moving image area 22mv during a period from the first operation to the second operation of the movie button 36mv is recorded into the recording medium 30 in a moving-image file format.

When a determined result of the step S17 is NO, in a step S25, it is determined whether or not the shutter button 36sh is half depressed. When a determined result is NO, the process returns to the step S13 whereas when the determined result is YES, the process advances to a step S27. In the step S27, the AE process for a still image is executed, and in a step S29, the AF process for a still image is executed. As a result, a luminance and a sharpness of image data based on output of the optical/imaging system STL are adjusted to optimal values.

In a step S31, it is determined whether or not the shutter button 36sh is fully-depressed, and in a step S33, it is determined whether or not the operation of the shutter button 36sh is cancelled. When a determined result of the step S33 is YES, the process returns to the step S13. When the determined result of the step S31 is YES, it is regarded that the still-image shooting mode is selected, and thereafter, the process advances to a step S35.

In the step S35, the still-image taking process is executed, and in a step S37, the still-image recording process is executed. As a result of the process in the step S35, the latest one frame of the image data stored in the still image area 22stl is evacuated to the evacuation area 22sv. Moreover, as a result of the process in the step S37, a still image file in which the evacuated image data is contained is recorded in the recording medium 30.

In a step S39, it is determined whether or not the moving-image recording process is being executed, and when a determined result is NO, the process directly returns to the step S13 whereas when the determined result is YES, the process returns to the step S13 via a process in a step S41. In the step S41, in order to form a link between the moving image file created by the moving-image recording process and the still image file created by the still-image recording process, a file name of the moving image file is described in a header of the still image file, and a file name of the still image file is described in the file name of the moving image file.

With reference to FIG. 11, in a step S51, it is determined whether or not the moving-image recording process is being executed, and in a step S53, it is determined whether or not the illuminance is equal to or less than the reference value REF 1, based on the luminance evaluation values outputted from the AE/AF evaluating circuits 16a and 16b. When both of a determined result of the step S51 and a determined result of the step S53 are YES, the video light 38 is turned on in a step S55. In contrary, when the determined result of the step S51 or the determined result of the step S53 is NO, the video light 38 is turned off in a step S57.

Upon completion of the process in the step S55 or S57, in a step S59, it is determined whether or not the shutter button 36sh is fully-depressed, and in a step S61, it is determined whether or not the illuminance is equal to or less than the reference REF2. When any one of determined results is NO, the process directly returns to the step S51 whereas when both of the determined results are YES, the video light 38 is turned off in a step S63, the strobe light 40 is emitted light in a step S65, and thereafter, the process returns to the step S51.

As can be seen from the above-described explanation, the optical/imaging systems 12a and 12b are respectively corresponding to the video light 38 and the strobe light 40 each of which emits in a mutually different manner. The CPU 34 selects a desired shooting mode out of the moving-image shooting mode and the still-image shooting mode (S17, S31), drives an emitting device corresponding to the selected shooting mode out of the video light 38 and the strobe light 40 (S55, S65), and records image data representing a scene captured in the optical/imaging system corresponding to the driven emitting device (S35 to S37).

Thus, provided are a plurality of shooting modes (the moving-image shooting mode and the still-image shooting mode) in each of which a scene is captured in a mutually different manner and a plurality of emitting devices (the video light 38 and the strobe light 40) each of which emits in a mutually different manner and driven is the emitting device corresponding to the selected shooting mode. The image data to be recorded represents the scene captured in the optical/imaging system corresponding to the driven emitting device. Thereby, it becomes possible to correspond to a wide range of imaging conditions, by extension, it becomes possible to improve a quality of the recorded image.

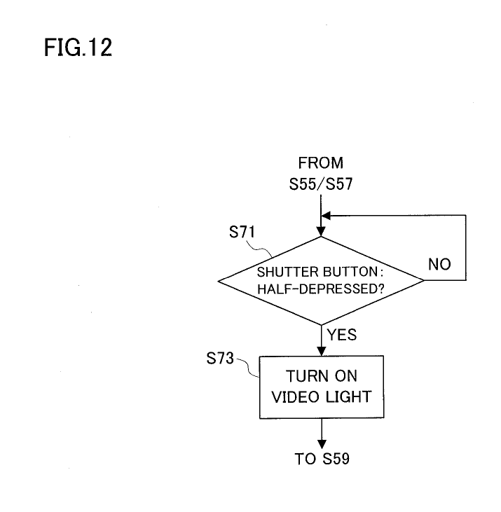

It is noted that, in this embodiment, the video light 38 is turned on when the illuminance is equal to or less than the reference value REF1, whereas is turned off when the illuminance exceeds the reference value REF1 (see the steps S53 to S57 shown in FIG. 11). However, the video light 38 may be temporarily turned on irrespective of the illuminance, at a timing of executing a still-image AF process in response to a half-depression of the shutter button 36sh. In this case, it is necessary to add a step S71 of determining whether or not the shutter button 36sh is half-depressed and a step S73 of turning on the video light 38 when a determined result is updated from NO to YES between the process in the step S55 or S57 and the step S59 shown in FIG. 11 (see FIG. 12). Thereby, it becomes possible to use the video light 38 as a fill light of the AF process, and as a result, an accuracy of the still-image AF process is improved.

Moreover, in this embodiment, a timer shooting mode for executing the still-image taking process at a time point at which a designated time period has elapsed since the shutter button 36sh is fully depressed is not installed. However, the timer shooting mode may be prepared so as to notify a subject of a timing of executing the still-image taking process by blinking the video light 38.

Furthermore, in this embodiment, no countermeasure is provided for avoiding an appearance of red-eye resulting from a light-emission of the strobe light 40. However, the video light 38 may be blinked before emitting the strobe light 40 so as to avoid the appearance of the red-eye.

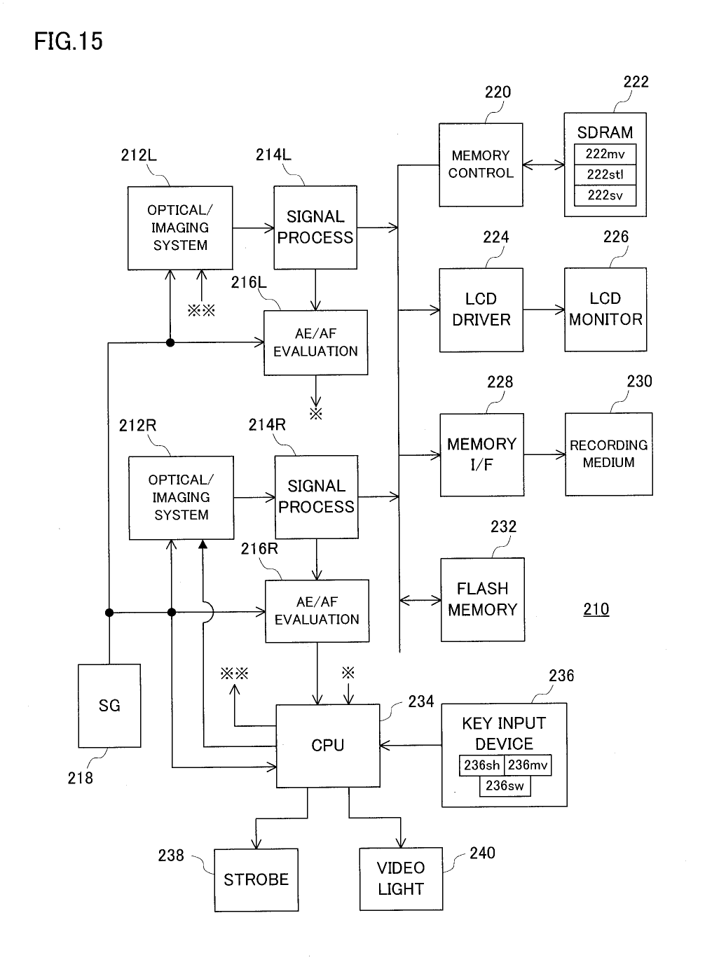

Moreover, in this embodiment, the video light 38 is temporarily turned off and the strobe light 40 is emitted when the shutter button 36sh is fully depressed in a state where the video light 38 is turned on (see the steps S59 to S65 shown in FIG. 15). However, the video light 38 may be continuously turned on irrespective of the strobe light 40 being emitted, and furthermore, turning on/off the video light 38 at a time point at which the strobe light 40 is emitted may be shifted according to a user setting.

However, when both of the strobe light 40 and the video light 38 are emitted or turned on in response to the shutter button 36sh being fully depressed in a dark place, a brightness of a subject in a close range is secured by the strobe light 40 being emitted, a brightness of a subject in a middle range is secured by the video light 38 being turned on, and a brightness of a subject in a long range is secured by extending the exposure time period.

Furthermore, in this embodiment, a macro photographing mode is not installed for photographing a subject a few centimeters to a dozen centimeters distant as a still image. However, the macro photographing mode may be provided so as to turn on the video light 38 when this mode is activated.

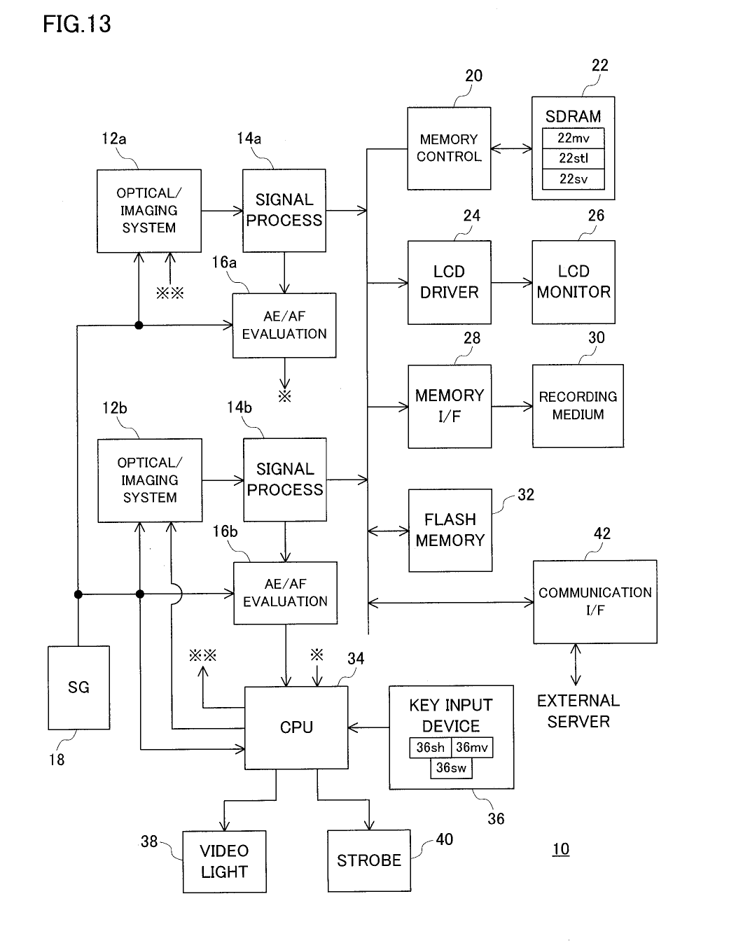

It is noted that, in this embodiment, the control programs equivalent to the multi task operating system and the plurality of tasks executed thereby are previously stored in a flash memory 32. However, a communication I/F 42 may be arranged in the digital camera 10 as shown in FIG. 13 so as to initially prepare a part of the control programs in the flash memory 32 as an internal control program whereas acquire another part of the control programs from an external server as an external control program. In this case, the above-described procedures are realized in cooperation with the internal control program and the external control program.

Moreover, in this embodiment, the processes executed by the CPU 34 are divided into a plurality of tasks in the above-described manner. However, each of tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Moreover, in this embodiment, one of the optical/imaging systems 12a and 12b is associated with the moving-image shooting mode, and concurrently, the other of the optical/imaging systems 12a and 12b is associated with the still-image shooting mode so as to create a moving image file based on output of the one of the optical/imaging systems and create a still image file based on output of the other of the optical/imaging systems. However, a three-dimensional image mode may be provided separately from the moving-image shooting mode or the still-image shooting mode so as to create three-dimensional image data based on the outputs of the optical/imaging systems 12a and 12b and contain the created three-dimensional image data into a three-dimensional image file. At this time, the three-dimensional image file may be any of the still-image file and the moving-image file.

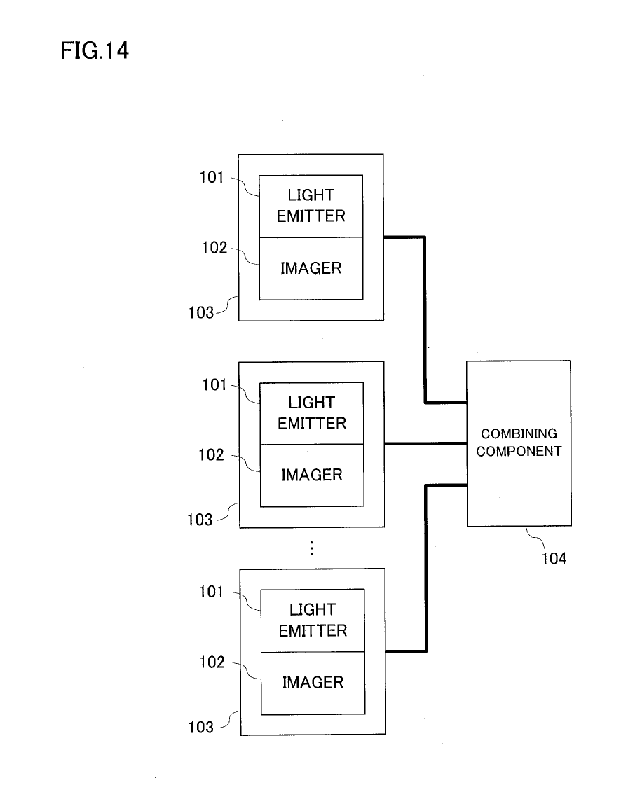

With reference to FIG. 14, an electronic camera according to one embodiment is basically configured as follows: Each of a plurality of light emitters 101, 101, . . . emits light in a mutually different manner. A plurality of imaging systems 102, 102, . . . are respectively corresponding to the plurality of light emitters 101, 101, . . . and respectively output a plurality of electronic images each of which has a mutually different quality. Each of a plurality of holding members 103, 103, . . . integrally holds a light emitter 101 and an imaging system 102 corresponding to each other. A combining member 104 combines the plurality of holding members 103, 103, . . . with one another in a manner in which relative attitudes of the plurality of holding members 103, 103, . . . become variable.

Thus, light emitting manners are different among the plurality of light emitters 101, 101, . . . , and qualities of the outputted images are different among the plurality of imaging systems 102, 102, . . . . The light emitter 101 and the imaging system 102 corresponding to each other are integrally held by a common holding member 103, and the plurality of holding members 103, 103, . . . are combined with one another in the manner in which relative attitudes become variable. Thereby, representing an electronic image outputted from the imaging system 102 becomes diversified.

With reference to FIG. 15, a digital camera 210 according to one embodiment includes optical/imaging systems 212L and 212R capturing a common scene. When a power source is applied, under an imaging task executed by a CPU 234, the optical/imaging systems 212L and 212R are activated. In response to a vertical synchronization signal Vsync periodically generated from an SG (Signal Generator) 218, both of the optical/imaging systems 212L and 212R repeatedly output raw image data representing a scene.

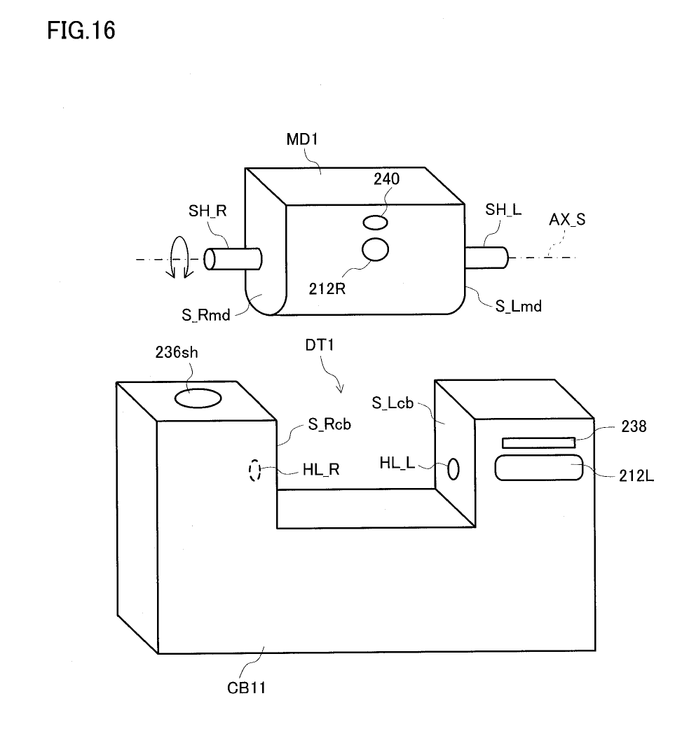

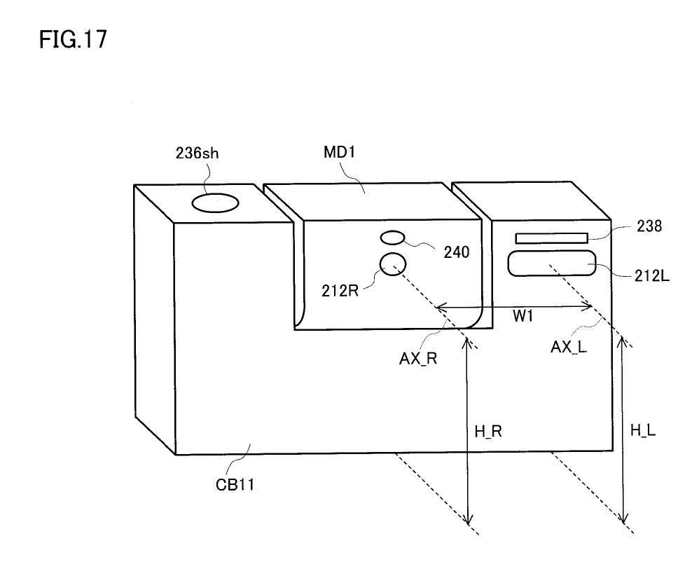

As shown in FIG. 16 and FIG. 17, the digital camera 210 is formed by a camera housing CB11 and a module MD1. A center of a top-surface of the camera housing CB11 is dented throughout a front-back direction, and a left inner-side surface S_Lcb and a right inner-side surface S_Rcb of a concave portion DT1 thus formed are flat and opposite to each other. Moreover, a circular hole HL_L extending in a left direction is formed in an approximately center of the left inner-side surface S_Lcb, and also, a circular hole HL_R extending in a right direction is formed in an approximately center of the right inner-side surface S_Rcb.

The module MD1 has a shape and a size fitting together to the concave portion DT1 of the camera housing CB11, and has a left outer-side surface S_Lmd facing the left inner-side surface S_Lcb and a right outer-side surface S_Rmd facing the right inner-side surface S_Rcb. However, corner portions connecting each of a front surface and a rear surface and a bottom surface of the module MD1 are rounded off. Thus, an outline of the bottom of the module MD1 is a U-shaped when the module MD1 is viewed from a horizontal direction.

Moreover, arranged in the module MD1 are a shaft SH_L projecting from an approximately center of the left outer-side surface S_Lmd to a left direction and a shaft SH_R projecting from an approximately center of the right outer-side surface S_Rmd to a right direction. An outer diameter of the shaft SH_L is slightly smaller than an inner diameter of the hole HL_L, and an outer diameter of the shaft SH_R is also slightly smaller than an inner diameter of the hole HL_R.

The module MD1 is attached to the camera housing CB11 by inserting the shaft SH_L into the hole HL_L and inserting the shaft SH_R into the hole HL_R. The module MD1 thus attached is capable of turning in a direction around a central axis AX_S of the shafts SH_L and SH_R, and relative attitudes of the module MD1 and the camera housing CB11 become variable from zero degree to 180 degrees by using the central axis AX_S as a reference.

The optical/imaging system 212L and a strobe light 238 are fixedly arranged on an upper left portion of a front surface of the camera housing CB11, and the optical/imaging system 212R and a video light 240 are fixedly arranged on the front surface of the module MD1. That is, the strobe light 238 and the optical/imaging system 212L are unified by the module MD1, and the video light 240 and the optical/imaging system 212R are unified by the camera housing CB11. Below, an attitude in which a direction of the optical/imaging system 212R is coincident with a direction of the optical/imaging system 212L is defined as a “reference attitude”.

As shown in FIG. 17, the optical/imaging systems 212L and 212R respectively have an optical axis AX_L and an optical axis AX_R. In the reference attitude, a distance from the bottom surface of the camera housing CB11 to the optical axis AX_R (=H_R) is coincident with a distance from the bottom surface of the camera housing CB11 to the optical axis AX_L (=H_L), and a width between the optical axes AXL and AXR in a horizontal direction (=W1) is set about six centimeters by considering a width between both eyes of a person.

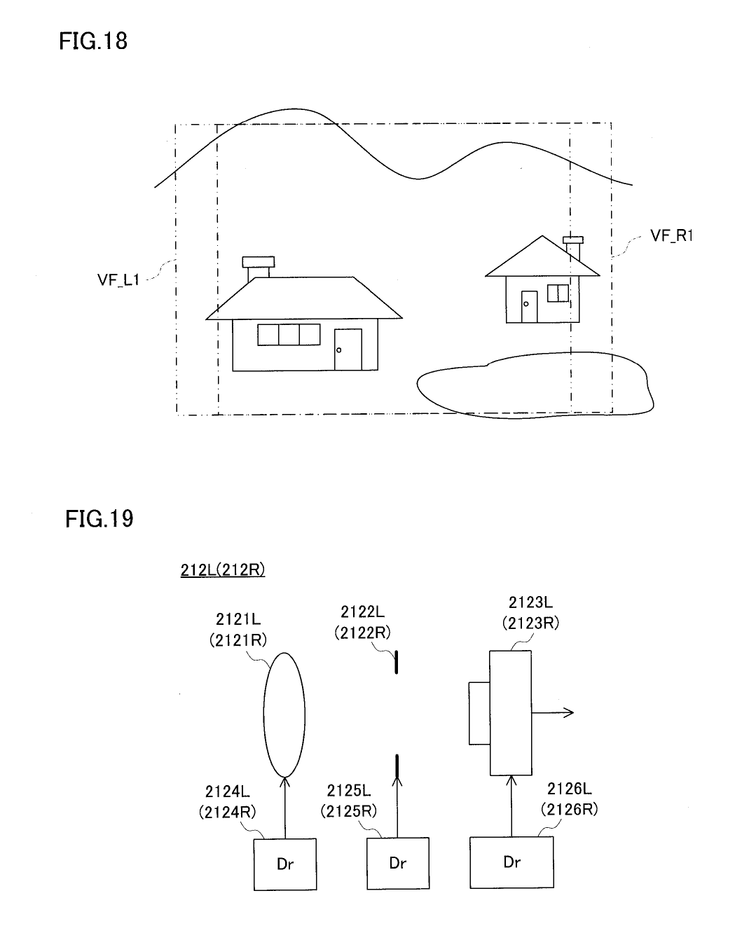

Thus, when the module MD 1 is set to the reference attitude in a state where a scene shown in FIG. 18 is spreading out before the camera housing CB11, the optical/imaging system 212L captures a scene belonging to a left-side viewing field VF_L1, whereas the optical/imaging system 212R captures a scene belonging to a right-side viewing field VF_R1. Since the optical/imaging systems 212L and 212R are arranged at the same height as each other in the camera housing CB11, horizontal positions of the viewing fields VF_L1 and VF_R1 are stirred, whereas vertical positions of the viewing fields VF_L1 and VF_R1 are coincident with each other.

Returning to FIG. 15, the raw image data outputted from the optical/imaging system 212L is applied to a signal processing circuit 214L, and the raw image data outputted from the optical/imaging system 212R is applied to a signal processing circuit 214R Each of the signal processing circuits 214L and 214R performs processes, such as color separation, white balance adjustment, and YUV conversion, on the applied raw image data so as to write image data that complies with the YUV format into an SDRAM 222 through a memory control circuit 220.

One of the optical/imaging systems 212L and 212R is corresponding to a moving-image shooting mode, and the other of the optical/imaging systems 212L and 212R is corresponding to a still-image shooting mode. Below, an optical/imaging system corresponding to the moving-image shooting mode is defined as “optical/imaging system MV”, and an optical/imaging system corresponding to the still-image shooting mode is defined as the “optical/imaging system STL”.

Initially when the power supply is applied, under a setting control task parallel to the imaging task, the CPU 234 initializes roles of the optical/imaging systems 212L and 212R. The optical/imaging system 212L is set as the “optical/imaging system MV”, and the optical/imaging system 212R is set as the “optical/imaging system STL”. Upon completion of initializing, illuminance of the scene captured by the optical/imaging systems 212L and 212R is calculated based on a luminance evaluation value described later, and the roles of the optical/imaging systems 212L and 212R are set in a manner different depending on a magnitude of the calculated illuminance.

A reference value REF1 for controlling light emission/non-light emission is assigned to the strobe light 238, and a reference value REF2 for controlling turning on/off is assigned to the video light 240. Here, the reference value REF1 is larger than the reference value REF2.

When the illuminance of the scene captured by the optical/imaging system 212L is equal to or less than the reference value REF1 or the illuminance of the scene captured by the optical/imaging system 212R is equal to or less than the reference value REF2, it is regarded that the strobe light 238 and/or the video light 240 is necessary. Therefore, the optical/imaging system 212L is set as the “optical/imaging system STL”, and the optical/imaging system 212R is set as the “optical/imaging system MV”. Also, when the video light 240 is being turned on at a current time point, the optical/imaging system 212L is set as the “optical/imaging system STL”, and the optical/imaging system 212R is set as the “optical/imaging system MV”.

In contrary, when the illuminance of the scene captured by the optical/imaging system 212L exceeds the reference value REF 1, the illuminance of the scene captured by the optical/imaging system 212R exceeds the reference value REF2 and the video light 240 is being turned of it is regarded that any of the strobe light 238 and the video light 240 is unnecessary, and therefore, the roles of the optical/imaging systems 212L and 212R are switched in response to an operation of an imaging setting switch 236sw.

Specifically, when the imaging setting switch 236sw is set to “ST1”, the optical/imaging system 212L is set as the “optical/imaging system STL”, and the optical/imaging system 212R is set as the “optical/imaging system MV”. On the other hand, when the imaging setting switch 236sw is set to “ST2”, the optical/imaging system 212L is set as the “optical/imaging system MV”, and the optical/imaging system 212R is set as the “optical/imaging system STL”.

In the SDRAM 222, image data representing a scene captured in the optical/imaging system MV is stored in a moving image area 222mv, whereas image data representing a scene captured in the optical/imaging system STL is stored in a still-image area 222stl. An LCD driver 224 repeatedly reads out the image data stored in the moving image area 222mv through the memory control circuit 220, and drives an LCD monitor 226 based on the read-out image data. As a result, a real-time moving image (a live view image) representing the scene captured in the optical/imaging system MV is displayed on a monitor screen.

With reference to FIG. 19, the optical/imaging system 212L has a focus lens 2121L, an aperture unit 2122L and an imaging device 2123L driven by a lens driver 2124L, an aperture driver 2125L and a sensor driver 2126L, respectively. An optical image representing the left-side viewing field VF_L1 enters, with irradiation, an imaging surface of the imaging device 2123L via the focus lens 2121L and the aperture unit 2122L.

Similarly, the optical/imaging system 212R has a focus lens 2121R, an aperture unit 2122R and an imaging device 2123R driven by a lens driver 2124R, an aperture driver 2125R and a sensor driver 2126R, respectively. An optical image representing the right-side viewing field VF_R1 enters, with irradiation, an imaging surface of the imaging device 2123R via the focus lens 2121R and the aperture unit 2122R

In response to a vertical synchronization signal Vsync applied from the SG 218, the sensor driver 2126L exposes the imaging surface of the imaging device 2123L and reads out electric charges produced thereby in a raster scanning manner. In response to a vertical synchronization signal Vsync applied from the SG 218, the sensor driver 2126R also exposes the imaging surface of the imaging device 2123R and reads out electric charges produced thereby in a raster scanning manner. As a result, raw image data based on the read-out electric charges is outputted from each of the imaging devices 2123L and 2123R.

It is noted that a performance of the optical/imaging system 212R is lower than a performance of the optical/imaging system 212L. Specifically, an optical performance of the focus lens 2121R is lower than an optical performance of the focus lens 2121L, and an output performance of the imaging device 2123R is also lower than an output performance of the imaging device 2123L. Thus, outputted from the optical/imaging system 212R is raw image data having a quality deteriorated than a quality of raw image data outputted from the optical/imaging system 212L.

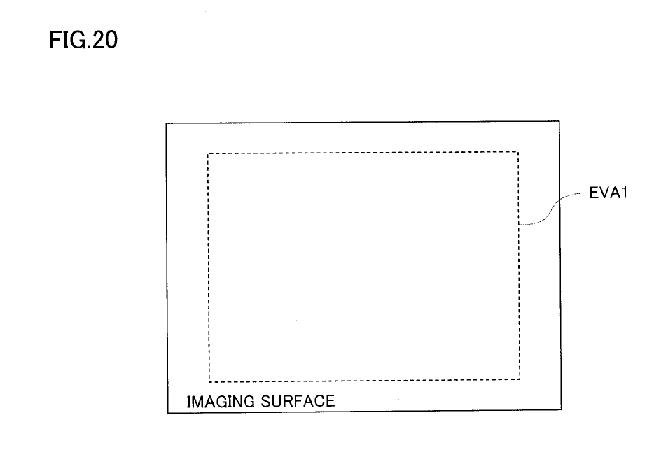

An evaluation area EVA1 is assigned to each of the imaging surfaces of the imaging devices 2123L and 2123R as shown in FIG. 20. An AE/AF evaluating circuit 216L shown in FIG. 15 repeatedly creates a luminance evaluation value and a focus evaluation value respectively indicating a brightness and a sharpness of the scene captured in the optical/imaging system 212L, based on partial image data belonging to the evaluation area EVA1 out of the YUV formatted image data produced by the signal processing circuit 214L.

Similarly, an AE/AF evaluating circuit 216R repeatedly creates a luminance evaluation value and a focus evaluation value respectively indicating a brightness and a sharpness of the scene captured in the optical/imaging system 212R, based on partial image data belonging to the evaluation area EVA1 out of the YUV formatted image data produced by the signal processing circuit 214R.

When the module MD1 indicates the reference attitude, the CPU 234 designates the luminance evaluation values outputted from both of the AE/AF evaluating circuits 216L and 216R as a reference luminance-evaluation value, and designates the focus evaluation values outputted from both of the AE/AF evaluating circuits 216L and 216R as a reference focus-evaluation value.

In contrary, when the module MD1 indicates an attitude different from the reference attitude, the CPU 234 designates only the luminance evaluation value outputted from the AE/AF evaluating circuit corresponding to the optical/imaging system MV as the reference luminance-evaluation value, and designates only the focus evaluation value outputted from the AE/AF evaluating circuit corresponding to the optical/imaging system MV as the reference focus-evaluation value.

Upon completion of designating the reference luminance-evaluation value and the reference focus-evaluation value, the CPU 234 executes, under the imaging task, an AE process for a moving image that is based on the reference luminance-evaluation value so as to calculate an aperture amount and an exposure time period defining an appropriate EV value. The aperture amount is set to both of the aperture drivers 2125L and 2125R corresponding to the reference attitude, and is set to only the aperture driver of the optical/imaging system MV corresponding to the attitude different from the reference attitude. The exposure time period is also set to both of the sensor drivers 2126L and 2126R corresponding to the reference attitude, and is set to only the sensor driver of the optical/imaging system MV corresponding to the attitude different from the reference attitude.

As a result, a luminance of the image data outputted from each of the signal processing circuits 214L and 214R is appropriately adjusted in the reference attitude, and a luminance of the image data outputted from the signal processing circuit corresponding to the optical/imaging system MV is appropriately adjusted in the attitude different from the reference attitude.

Moreover, the CPU 234 executes, under the imaging task, an AF process for a moving image that is based on the reference focus-evaluation value. The CPU 234 moves both of the focus lenses 2121L and 2121R, in the reference attitude, to a direction where a focal point exists, and moves only the focus lens 2121R, in the attitude different from the reference attitude, to the direction where the focal point exists.

As a result, a sharpness of the image data outputted from each of the signal processing circuits 214L and 214R is appropriately adjusted in the reference attitude, and a sharpness of the image data outputted from the signal processing circuit corresponding to the optical/imaging system MV is appropriately adjusted in the attitude different from the reference attitude.

When a movie button 236mv arranged in a key input device 236 is operated, the CPU 234 regards that the moving-image shooting mode is selected, and commands a memory I/F 228 to execute a moving-image recording process under the imaging task. The memory I/F 228 creates a new moving image file in a recording medium 230 (the created moving image file is opened), and repeatedly reads out the image data stored in the moving image area 222mv of the SDRAM 222 through the memory control circuit 220 so as to contain the read-out image data into the moving image file in an opened state.

When the movie button 236mv is operated again, the CPU 234 regards that a selection of the moving-image shooting mode is cancelled, and commands the memory I/F 228 to stop the moving-image recording process under the imaging task. The memory I/F 228 ends reading-out of the image data from the moving image area 222mv, and closes the moving image file in the opened state. Thereby, a moving image continuously representing a desired scene is recorded on the recording medium 230 in a file format.

An operation of a shutter button 236sh arranged in the key input device 236 is accepted under the imaging task irrespective of executing/interrupting the moving-image recording process. When the shutter button 236sh is half-depressed, under the imaging task, the CPU 234 executes an AE process for a still-image and an AF process for a still image that are based on the luminance evaluation value and the focus evaluation value outputted from the AE/AF evaluating circuit corresponding to the optical/imaging system STL.

As a result of the AE process for a still image, an aperture amount and an exposure time period defining an optimal EV value are calculated. The calculated aperture amount is set to the aperture driver arranged in the optical/imaging system STL, and the calculated exposure time period is set to the sensor drier arranged in the optical/imaging system STL. Thereby, a luminance of image data based on output of the optical/imaging system STL is adjusted to an optimal value.

Moreover, as a result of the AF process for a still image, the focus lens arranged in the optical/imaging system STL is placed at the focal point. Thereby, a sharpness of the image data based on output of the optical/imaging system STL is adjusted to an optimal value.

It is noted that, when the module MD1 indicates the reference attitude, the AE process for a moving image and the AF process for a moving image are repeatedly executed before the AE process for a still image and the AF process for a still image are executed. Therefore, manners of the AE process for a still image and the AF process for a still image are different depending on an attitude of the module MD1. Specifically, the focus lens is moved throughout a movable range of the lens in the attitude different from the reference attitude, whereas is moved only near the focal point in the reference attitude.

When the shutter button 236sh is full-depressed, the CPU 234 regards that the still-image shooting mode is selected, and executes a still-image taking process under the imaging task. As a result, the latest one frame of the image data stored in the still image area 222stl is evacuated to an evacuation area 222sv. Subsequently, the CPU 234 commands the memory I/F 228 to execute a still-image recording process under the imaging task.

The memory I/F 228 creates a new still image file in the recording medium 230 (the created still image file is opened), and repeatedly reads out the image data evacuated to the evacuation area 222sv through the memory control circuit 220 so as to contain the read-out image data into the still image file in an opened state. Upon completion of storing the image data, the memory I/F 228 closes the still image file in the opened state. Thereby, a moving image instantaneously representing a desired scene is recorded on the recording medium 230 in a file format.

When the still-image recording process is executed in the middle of the moving-image recording process, the CPU 234 forms a link between the moving image file created by the moving-image recording process and the still image file created by the still-image recording process. Specifically, a file name of the moving image file is described in a header of the still image file, and a file name of the still image file is described in the file name of the moving image file. Thereby, a diversity of representing a reproduced image is improved; such as reproducing a moving image and a still image representing a common scene in a parallel state or a composed state.

Moreover, under a light-emission control task parallel with the setting control task and the imaging task, the CPU 234 controls light emission/non-light emission of the strobe light 238 at a time point at which the shutter button 236sh is fully depressed and turning on/off of the video light 240 in executing the moving-image recording process. Upon controlling, the illuminances calculated based on the luminance evaluation values from the AE/AF evaluating circuits 216L and 216R are referred to.

The strobe light 238 is emitted when the illuminance is equal to or less than the reference REF1, whereas is set to non-light emission when the illuminance exceeds the reference REF1. Moreover, the video light 240 is turned on when the illuminance is equal to or less than the reference value REF2, whereas is turned off when the illuminance exceeds the reference value REF2. Thereby, a quality of the image data contained in each of the moving image file and the still image file is improved.

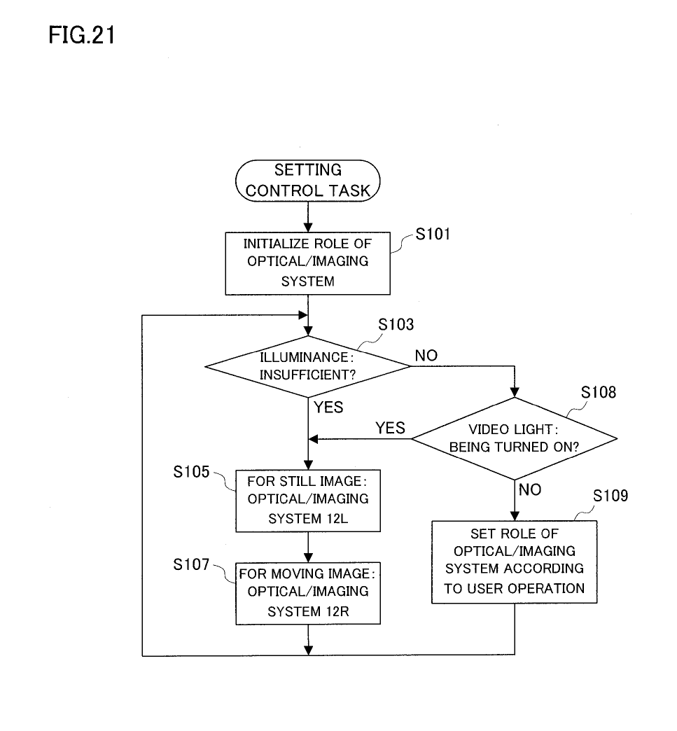

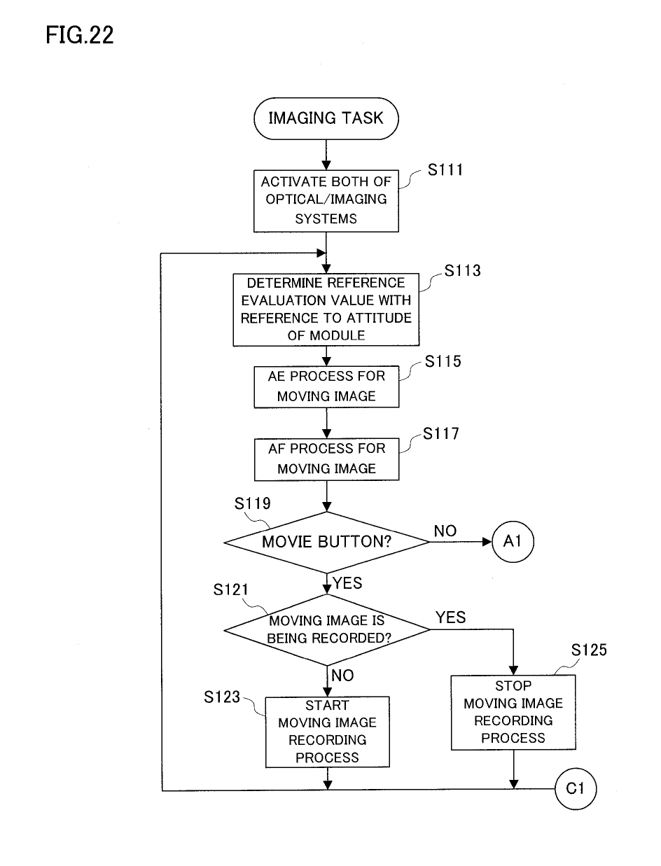

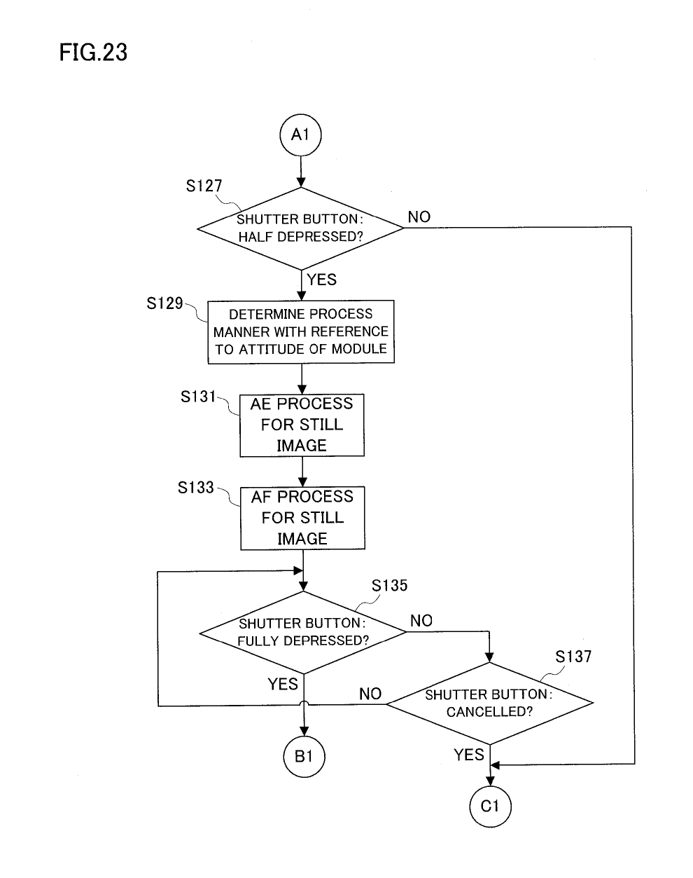

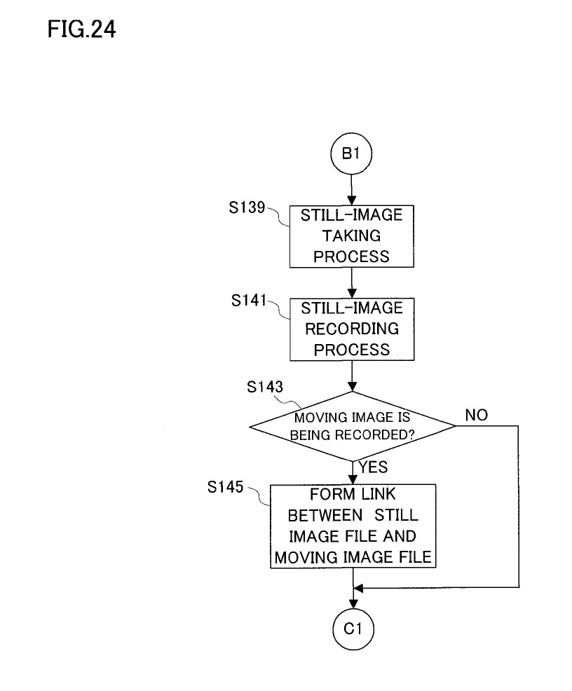

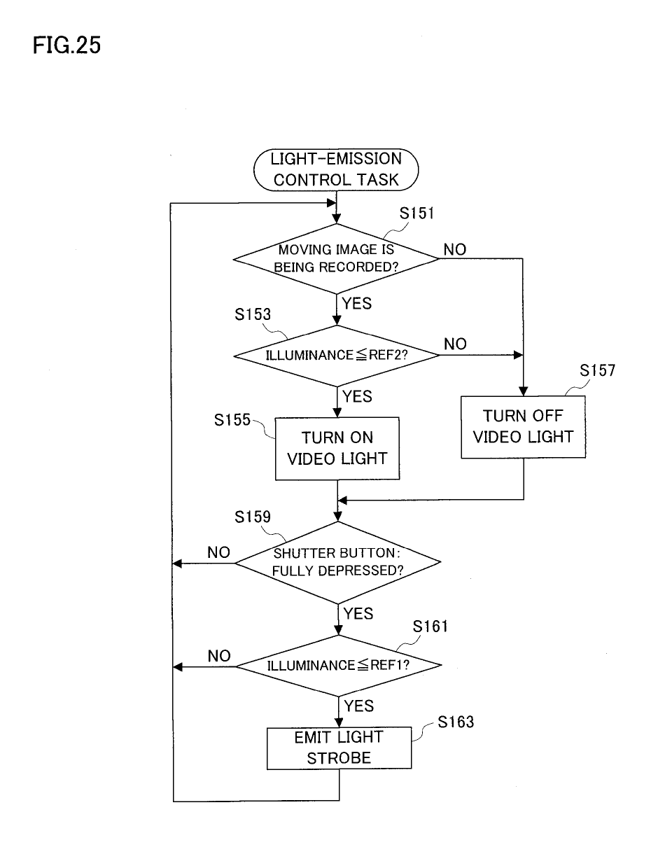

The CPU 234 executes, under a control of a multi task operating system, the setting control task shown in FIG. 21, the imaging task shown in FIG. 22 to FIG. 24 and the light-emission control task shown in FIG. 25, in a parallel manner.

With reference to FIG. 21, in a step S101, roles of the optical/imaging systems 212L and 212R are initialized. The optical/imaging system 212L is set as the “optical/imaging system STL”, and the optical/imaging system 212R is set as the “optical/imaging system MV”.

In a step S103, it is determined whether or not illuminance of the scene captured by the optical/imaging system 212L is equal to or less than the reference value REF1, based on a luminance evaluation value outputted from the AE/AF evaluating circuit 216L, and it is determined whether or not illuminance of the scene captured by the optical/imaging system 212R is equal to or less than the reference value REF2, based on a luminance evaluation value outputted from the AE/AF evaluating circuit 216R.

When the illuminance of the scene captured by the optical/imaging system 212L is equal to or less than the reference value REF1 or the illuminance of the scene captured by the optical/imaging system 212R is equal to or less than the reference value REF2, YES is determined in the step S103, and thereafter, the process advances to a step S105. In contrary, when the illuminance of the scene captured by the optical/imaging system 212L exceeds the reference value REF1 and the illuminance of the scene captured by the optical/imaging system 212R exceeds the reference value REF2, NO is determined in the step S103, and thereafter, the process advances to a step S108.

In the step S108, it is determined whether or not the video light 240 is being turned on, and when a determined result is YES, the process advances to the step S105 whereas when the determined result is NO, the process advances to a step S109.

In the step S105, the optical/imaging system 212L is set as “optical/imaging system STL”, and in a step S107, the optical/imaging system 212R is set as “optical/imaging system MV”. Upon completion of setting, the process returns to the step S103. In the step S109, the roles of the optical/imaging systems 212L and 212R are set according to a state of the imaging setting switch 236sw. Upon completion of setting, the process returns to the step S103.

As a result of the process in the step S109, when the imaging setting switch 236sw is set to “ST1”, the optical/imaging system 212L is set as the “optical/imaging system STL”, and the optical/imaging system 212R is set as the “optical/imaging system MV”. When the imaging setting switch 236sw is set to “ST2”, the optical/imaging system 212L is set as the “optical/imaging system MV”, and the optical/imaging system 212R is set as the “optical/imaging system STL”.

With reference to FIG. 22, in a step S111, the optical/imaging systems MV and STL are activated. As a result, image data representing a scene captured in the optical/imaging system MV is written into the moving image area 222mv of the SDRAM 222, image data representing a scene captured in the optical/imaging system STL is written into the still image area 222stl of the SDRAM 222, and a live view image that is based on the image data stored in the moving image area 222mv is displayed on the LCD monitor 226.

In a step S113, a reference luminance-evaluation value and a reference focus-evaluation value are decided in a manner different depending on an attitude of the module MD 1. In a reference attitude, the luminance evaluation values outputted from both of the AE/AF evaluating circuits 216L and 216R are designated as the reference luminance-evaluation value, and the focus evaluation values outputted from both of the AE/AF evaluating circuits 216L and 216R are designated as the reference focus-evaluation value. In contrary, in an attitude different from the reference attitude, only the luminance evaluation value outputted from the AE/AF evaluating circuit corresponding to the optical/imaging system MV is designated as the reference luminance-evaluation value, and only the focus evaluation value outputted from the AE/AF evaluating circuit corresponding to the optical/imaging system MV is designated as the reference focus-evaluation value.

In a step S115, the AE process for a moving image that is based on the reference luminance-evaluation value is executed, and in a step S117, the AF process for a moving image that is based on the reference focus-evaluation value is executed. As a result of the process in the step S115, luminances of the image data outputted from both of the signal processing circuits 214L and 214R are appropriately adjusted in the reference attitude, and a luminance of the image data outputted from the signal processing circuit corresponding to the optical/imaging system MV is appropriately adjusted in the attitude different from the reference attitude. Moreover, as a result of the process in the step S117, a sharpness of the image data outputted from each of the signal processing circuits 214L and 214R is appropriately adjusted in the reference attitude, and a sharpness of the image data outputted from the signal processing circuit corresponding to the optical/imaging system MV is appropriately adjusted in the attitude different from the reference attitude.

In a step S119, it is determined whether or not the movie button 236mv is operated, and when a determined result is YES, the process advances to a step S121. In the step S121, it is determined whether or not a moving-image process is being executed, and when a determined result is YES, it is regarded that the moving-image shooting mode is selected, and thereafter, the moving-image recording process is started in a step S123, whereas when the determined result is NO, it is regarded that a selection of the moving-image shooting mode is cancelled, and thereafter, the moving-image recording process is stopped in a step S125. Upon completion of the process in the step S123 or S125, the process returns to the step S113.

As a result of the processes in the steps S123 and S125, the image data taken into the moving image area 222mv during a period from the first operation to the second operation of the movie button 236mv is recorded into the recording medium 230 in a moving-image file format.

When a determined result of the step S119 is NO, in a step S127, it is determined whether or not the shutter button 236sh is half depressed. When a determined result is NO, the process returns to the step S113 whereas when the determined result is YES, the process advances to a step S129. In the step S129, a manner of the AE process and a manner of the AF process are decided with reference to an attitude of the module MD1, and in steps S131 and S133, the AE process for a still image and the AF process for a still image are executed in the decided manners. As a result, a sharpness and a luminance of image data based on output of the optical/imaging system STL are adjusted to optimal values.

In a step S135, it is determined whether or not the shutter button 236sh is fully-depressed, and in a step S137, it is determined whether or not the operation of the shutter button 236sh is cancelled. When a determined result of the step S137 is YES, the process returns to the step S113. When the determined result of the step S135 is YES, it is regarded that the still-image shooting mode is selected, and thereafter, the process advances to a step S139.

In the step S139, the still-image taking process is executed, and in a step S141, the still-image recording process is executed. As a result of the process in the step S139, the latest one frame of the image data stored in the still image area 222stl is evacuated to the evacuation area 222sv. Moreover, as a result of the process in the step S141, a still image file in which the evacuated image data is contained is recorded in the recording medium 230.

In a step S143, it is determined whether or not the moving-image recording process is being executed, and when a determined result is NO, the process directly returns to the step S113 whereas when the determined result is YES, the process returns to the step S113 via a process in a step S145. In the step S145, in order to form a link between the moving image file created by the moving-image recording process and the still image file created by the still-image recording process, a file name of the moving image file is described in a header of the still image file, and a file name of the still image file is described in the file name of the moving image file.

With reference to FIG. 25, in a step S151, it is determined whether or not the moving-image recording process is being executed, and in a step S153, it is determined whether or not the illuminance is equal to or less than the reference value REF2, based on the luminance evaluation values outputted from the AE/AF evaluating circuits 216L and 216R. When both of a determined result of the step S151 and a determined result of the step S153 are YES, the video light 240 is turned on in a step S155. In contrary, when the determined result of the step S151 or the determined result of the step S153 is NO, the video light 240 is turned off in a step S157.

Upon completion of the process in the step S155 or S157, in a step S159, it is determined whether or not the shutter button 236sh is fully-depressed, and in a step S161, it is determined whether or not the illuminance is equal to or less than the reference REF1. When any one of determined results is NO, the process directly returns to the step S151 whereas when both of the determined results are YES, the strobe light 238 is emitted light in a step S163, and thereafter, the process returns to the step S151.

As can be seen from the above-described explanation, the optical/imaging system 212L is assigned to the strobe light 238 which instantaneously generates a light, and outputs high-quality raw image data. On the other hand, the optical/imaging system 212R is assigned to the video light 240 which continuously generates the light, and outputs low-quality raw image data. The strobe light 238 and the optical/imaging system 212L are integrally held by the camera housing CB11, and the video light 240 and the optical/imaging system 212R are integrally held by the module MD1. The module MD1 and the camera housing CB11 are combined with each other by the shafts SH_L and SH_R so as to be capable of turning in a direction around the axis AX_S, and relative attitudes of the module MD 1 and the camera housing CB11 are changed by using the axis AX_S as a reference.

Thus, light emitting manners are different between the strobe light 238 and the video light 240, and qualities of the raw image data are different between the optical/imaging systems 212L and 212R The strobe light 238 and the optical/imaging system 212L are held by the camera housing CB11, the video light 240 and the optical/imaging system 212R are held by the module MD1, and the module MD1 and the camera housing CB11 are combined with each other by the shafts SH_L and SH_R so as to be capable of turning in the direction around the reference axis AX_S. Thereby, representing the raw image data outputted from the optical/imaging systems 212L and 212R becomes diversified.

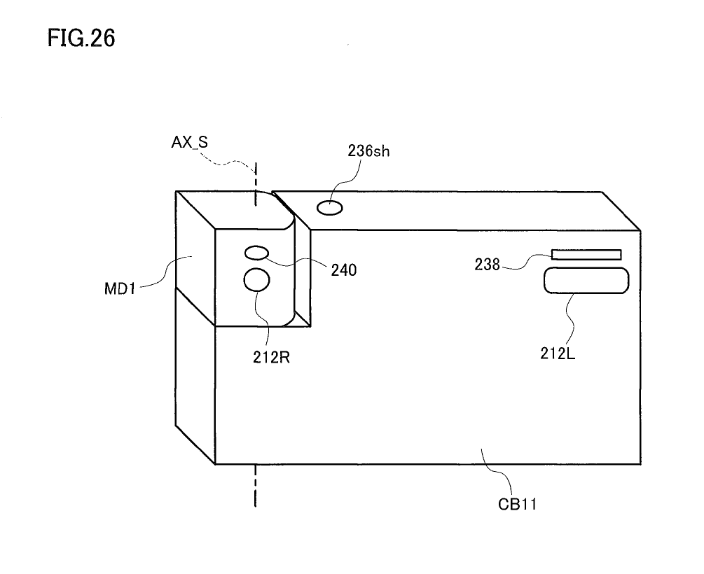

It is noted that, in this embodiment, the module MD1 is turned in the direction around the axis AX_S extending in the horizontal direction. However, as shown in FIG. 26, the module MD1 may be attached on the right side of the camera housing CB11 so as to be capable of turning in a direction around the axis AX_S extending in a vertical direction, by turning the optical/imaging system 212R and the video light 240 90 degrees in a direction around the optical axis AX_R and installing on the module MD1 (at this time, a height of the optical/imaging system 212R is coincident with a height of the optical/imaging systems 212L). Thereby, it becomes possible to perform the three-dimensional photography and the panoramic photography by using the optical/imaging systems 212L and 212R.

However, both in the three-dimensional photography and the panoramic photography, it is necessary to acquire L-side image data and R-side image data having common pixels and sensitivity at the same time. Furthermore, in a case of the three-dimensional photography, it is necessary to adjust a turning angle of the module MD 1 by considering a subject distance, and in a case of the panoramic photography, it is necessary to combine the acquired L-side image data and R-side image data each other by using a common viewing field as the “overlap width”.

It is noted that, both in cases where the module MD1 is attached as shown in FIG. 17 and where the module MD1 is attached as shown in FIG. 26, it becomes possible to photograph a user him/herself (so-called self shooting) by forming the module MD1 cylindrically and turning the module MD1 180 degrees from the reference attitude.

Moreover, in this embodiment, a single module MD1 is attached to the camera housing CB11, however, a plurality of modules each of which has the optical/imaging system may be attached to the camera housing CB11. Thereby, it becomes possible to capture more than three viewing fields at the same time.

Furthermore, in this embodiment, the still-image taking process and the still-image recording process are executed in response to the operation of the shutter button 236sh, a function for detecting an expression of a photographer's face may be installed so as to execute the still-image taking process and the still-image recording process when the expression of the photographer's face indicates a predetermined expression. Moreover, in this embodiment, a link is formed between the moving image file and the still image file when the still-image recording process is executed in the middle of the moving-image recording process. As a reproducing manner of two images thus associated with, a so-called picture-in-picture reproduction etc. for reproducing the moving image on the still image may be considered.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
a plurality of light emitters each of which emits light in a mutually different manner;
a plurality of optical systems respectively corresponding to said plurality of light emitters;
a selector which selects a desired shooting mode from among a plurality of shooting modes in each of which a scene is captured in a mutually different manner;
a driver which drives a light emitter corresponding to the shooting mode selected by said selector out of said plurality of light emitters; and
a creator which creates an electronic image based on an optical image went through an optical system corresponding to the light emitter driven by said driver out of the plurality of optical systems.

2. An electronic camera according to claim 1, further comprising:
a changer which changes a correspondence relationship between said plurality of light emitters and the plurality of optical systems, in accordance with a user operation; and
a restrictor which restricts a changing process of said changer when a brightness of the scene is equal to or less than a reference.

3. An electronic camera according to claim 1, wherein the plurality of optical systems are arranged on a plurality of positions different from one another of a camera housing so as to redundantly capture the scene.

4. An electronic camera according to claim 1, wherein the plurality of shooting modes include a moving-image shooting mode in which the scene is continuously captured and a still-image shooting mode in which the scene is instantaneously captured, said plurality of light emitters include a first generator which continuously generates a light and a second generator which instantaneously generates a light, and said driver includes a first driver which drives the first generator corresponding to the moving-image shooting mode and a second driver which drives the second generator corresponding to the still-image shooting mode.

5. An electronic camera according to claim 4, wherein said selector accepts a selection of the still-image shooting mode irrespective of a selection/non-selection of the moving-image shooting mode, and said creator includes an assigner which assigns a still image representing a scene captured under the still-image shooting mode to a moving image representing a scene captured under the moving-image shooting mode parallel to the still-image shooting mode.

6. An electronic camera according to claim 5, further comprising a stopper which stops said first light emitter at a timing of the scene being captured under the still-image shooting mode.

7. An electronic camera according to claim 4, further comprising a third driver which drives said first generator corresponding to the selection of the still-image shooting mode.

8. An imaging control program recorded on a non-transitory recording medium in order to control an electronic camera provided with a plurality of light emitters each of which emits light in a mutually different manner and a plurality of optical systems respectively corresponding to said plurality of light emitters, the program causing a processor of the electronic camera to perform the steps comprising:
a selecting step of selecting a desired shooting mode from among a plurality of shooting modes in each of which a scene is captured in a mutually different manner;
a driving step of driving a light emitter corresponding to the shooting mode selected by said selecting step out of said plurality of light emitters; and
a creating step of creating an electronic image based on an optical image went through an optical system corresponding to the light emitter driven by said driving step out of the plurality of optical systems.

9. An imaging control method executed by an electronic camera provided with a plurality of light emitters each of which emits light in a mutually different manner and a plurality of optical systems respectively corresponding to said plurality of light emitters, comprising:
a selecting step of selecting a desired shooting mode from among a plurality of shooting modes in each of which a scene is captured in a mutually different manner;
a driving step of driving a light emitter corresponding to the shooting mode selected by said selecting step out of said plurality of light emitters; and
a creating step of creating an electronic image based on an optical image went through an optical system corresponding to the light emitter driven by said driving step out of the plurality of optical systems.

10. An electronic camera, comprising:
a plurality of light emitters each of which emits light in a mutually different manner;
a plurality of imagers which respectively correspond to said plurality of light emitters and respectively output a plurality of electronic images each of which has a mutually different quality;
a plurality of holding members each of which integrally holds a light emitter and an imager corresponding to each other; and
a combining member which combines said plurality of holding members with one another in a manner in which relative attitudes of said plurality of holding members become variable.

11. An electronic camera according to claim 10, wherein said combining member holds said plurality of holding members so that each of said plurality of holding members is capable of turning in a direction around a predetermined axis.

12. An electronic camera according to claim 10, wherein a plurality of viewing fields respectively captured by said plurality of imagers in a predetermined relative attitude are lined up on a same vertical position so as to be partially overlapped in a horizontal direction.

13. An electronic camera according to claim 10, further comprising an association processor which associates the plurality of electronic images respectively outputted from said plurality of imagers with one another.

14. An electronic camera according to claim 10, wherein said plurality of light emitters include a first generator which generates instantaneously a light and a second generator which continuously generates the light, and said plurality of imagers include a first imager which corresponds to said first generator and outputs a first-quality electronic image, and a second imager which corresponds to said second generator and outputs a second-quality electronic image.

15. An electronic camera according to claim 10, further comprising:
an assigner which respectively assigns, to said plurality of imagers, a plurality of shooting modes in each of which a scene is captured in a mutually different manner;
a selector which selects a desired shooting mode from among the plurality of shooting modes; and
a recorder which records an electronic image outputted from an imager corresponding to the shooting mode selected by said selector out of said plurality of imagers.

16. An electronic camera according to claim 15, further comprising:
a changer which changes a correspondence relationship between the plurality of shooting modes and the plurality of imagers, in accordance with a user operation; and
a restrictor which restricts a changing process of said changer when a brightness of the scene is equal to or less than a reference.

17. An electronic camera according to claim 15, wherein the plurality of shooting modes include a moving-image shooting mode in which the scene is continuously captured and a still-image shooting mode in which the scene is instantaneously captured.
